(19) United States
(12) Patent Application Publication
(10) Pub. No.: US 2018/0319563 A1
(43) Pub. Date: Nov. 8, 2018

(54) A METHOD OF PRODUCING A SNACK-SIZED THERMALLY PROCESSED MEAT-BASED PRODUCT IN A PEELABLE PACKAGE

(71) Applicant: NOVAPLOT ENTERPRISES LTD., Limassol (CY)

(72) Inventor: Emmanouil DOMAZAKIS, (US)

(21) Appl. No.: 15/580,911

(22) PCT Filed: Nov. 23, 2015
(86) PCT No.: PCT/EP2015/077367

§ 371 Date: Dec. 8, 2017

(30) Foreign Application Priority Data
Jun. 9, 2015 (GR) 20150200068

(51) Int. Cl. B65D 75/58; A22C 13/00; A23L 13/60; B65D 65/38; B65D 75/06; B65D 85/72

(52) U.S. Cl. CPC B65D 75/5844; A22C 13/0013; A23L 13/65; B65D 65/38; A23V 2002/00; B65D 85/72; A22C 2013/0036; A22C 2013/0053; A22C 2013/0063; B65D 75/06

(57) ABSTRACT

The present invention is related to a method of producing a snack-sized thermally processed meat-based product, provided in an easy-to-peel tubular package. Moreover, a snack-sized thermally processed meat product provided in an easy-to-peel tubular package, is herein disclosed.

The present invention is related to a method of producing a snack-sized thermally processed meat-based product, provided in an easy-to-peel tubular package. Moreover, a snack-sized thermally processed meat product provided in an easy-to-peel tubular package, is herein disclosed.

The food casing materials that are conventionally used for thermally processed meat-based products encased in chubs, are either natural (obtained from intestines of young ruminants and pigs), or artificial (made of cellulose, collagen-based, synthetic materials). Certain casing materials are edible (e.g. collagen sausage casings), while others need to be peeled-off following thermal treatment (e.g. cellulose casings as in the case of frankfurter-type sausages). The synthetic casings used for the production of thermally processed meat-based products of bologna type, for example, may be either single-layered or multi-layered and constitute the safer solution for assuring the microbiological safety of the product. They present limited permeability to oxygen (e.g. <15 cm³/m²/d at 23° C. and 53% RH) and allow longer shelf life. Such synthetic polymer-based casings, however, do not allow the removal of the casing from the end-product by hand, and an easy access to the product. It is also common that meat preparations like Bolognas are provided in chubs of about 300 gr, encased into synthetic polymer-based casings, or they are provided sliced in packages of 100-200 gr of product (average slice weight of 20 gr). Thus, with the opening of the package, the whole product is exposed to quality deterioration factors.

It is an object of the present invention to provide, a method of producing a raw meat preparation suitable for producing thermally processed snack-sized meat-based products, provided in an easy-to-peel tubular package. It is a further object of the present invention that the thermally processed snack-size meat-based products, which are provided in an easy-to-peel tubular package are characterized by stability and excellent organoleptic properties (e.g. juiciness and desired bite effect).

Easy-to-peel packages offer the benefit of convenience, e.g. easy removal of the package and exposure of the enclosed product, without the use of a utensil. Thus, consumption is allowed anytime of the day, anywhere. In addition, snack-sized portions of meat products provided in easy-to-peel packages offer the additional benefit of allowing the consumption of a portion or certain number of portions, without exposing larger product quantities into quality deterioration factors. A snack-sized cooked meat product, enclosed in an easy-to-peel tubular package would be particularly suitable for use by children.

The present invention is related to the making of thermally processed, snack-sized meat-based products provided in an easy-to-peel tubular package. According to the present invention, the easy-to-peel tubular package is preferably a “cook in-ship in” package. In the “cook in-ship in” applications, the meat product is cooked and shipped in the same bag. The use of an easy-to peel package serves the intended use of said products.

Attempts to produce thermally processed snack-sized meat based products of solid nature in peelable casings in a “cook in-ship in” application have been made, but the final product was characterized by an excess of jelly between the meat product and the casing material, an undesirable feature.

The use of easy-to-peel packages, having a longitudinal heat sealed seam of heat-sealable packaging film, adds further technological complications. According to the present invention, the seal strength has to be such that allows easy peelability by children. This feature inevitably lowers the mechanical strength of the package.

The intended purpose of the present invention is accomplished by a raw meat preparation characterized by appropriate viscoelastic properties and formulation. Said viscoelastic properties are measured and determined with small deformation oscillatory measurements using a rheometer in a controlled shear stress or strain mode (e.g. Physica MCR300), by performing a frequency sweep test and an amplitude (strain) sweep test. Viscoelastic characterization takes place on the day of production of the meat preparation. Prior to testing, the meat preparation is kept at a temperature lower than or equal to 15° C. In the present invention, the oscillatory shear tests were performed at 15° C.

The Loss Modulus is a measure of the energy dissipated in a material in which a deformation has been imposed. Loss modulus can be thought of that proportion of the total rigidity (the complex modulus) of a material that is attributable to viscous flow, rather than elastic deformation. It is symbolized as G″ and is reported in Pascals (Pa). The Storage Modulus is a measure of the energy stored in a material in which a deformation has been imposed. The Storage Modulus can be thought of that proportion of the total rigidity (the complex modulus) of a material that is attributable to elastic deformation. It is symbolised as G′ and is typically reported in Pascals (Pa). The raw meat preparation of the present invention is of gel nature (the storage modulus G′ is always higher to the loss modulus G″, phase angle less than 45°, for several decades of frequency), as determined via a frequency sweep test (0.1 to 100 Hz). In addition, the raw meat preparation is further characterized by an amplitude sweep test (strain or stress), to obtain the “flow point”, the “complex viscosity at flow point” values, and the storage modulus in the linear viscoelastic region. During an amplitude sweep test, the shear stress or strain is varied while the frequency is kept constant, in this instance 1 Hz. At the crossover point G′=G″, the elastic behavior (G′>G″) changes to a viscous behavior (G″>G′), and this point is defined as the “flow point”. In other terms, the “flow point” is the stress value at which the internal structure is broken to the extent that the material starts to flow; i.e. phase angle (δ)=45° or tans δ=1.

According to the present invention, the raw meat preparation has a stress value at flow point, at a temperature of 15° C. and at a frequency of 1 Hz, lower than 2000 Pa, preferably lower than 1800 Pa and more preferably lower than 1650 Pa. In addition and under the same conditions the complex viscosity at flow point of said raw meat preparation is lower than 450 Pa*s, preferably lower than 400 Pa*s and more preferably lower than 350 Pa*s.

The above specifications determine a number of raw meat preparations, suitable for applications in cooked sausages of various types, e.g. one-phase meat-based products, two-phase meat-based products, reconstituted meat-based products etc. Said number of meat preparations are usually characterized by a G′ in the linear viscoelastic region less than 40,000 Pa, preferably less than 30,000 Pa and more preferably than 20,000 Pa.

The raw meat preparation of the present invention is further characterized by a protein-to-moisture ratio, which may range between 1:3 to 1:7, depending on the intended type of the final product, the desired protein content and the desired fat content. Preferably, the raw meat preparation derives from raw meat items, i.e. from meat items that have not been previously subjected to a heat treatment (e.g. blanching).

The desired “flow point” and “complex viscosity at flow point” values may be thus obtained by the use of the above protein-to-moisture ratio, and quantities of “other” ingredients adjusted accordingly. The term “other ingredients” refers to the group comprising: thickeners or gelling agents (e.g. starches, maltodextrin, carrageenan, gums, collagen and derivatives thereof etc), emulsifying agents (e.g. mono-and diglycerides of fatty acids, etc), proteins of animal origin (plasma proteins, milk proteins, egg proteins etc), proteins of plant origin (e.g. soya protein or soya protein isolate (SPI), lecithin, pea proteins etc), stabilizers (e.g. phosphates) and other processing aids.

In the context of the present invention, the term “thermally processed snack-sized meat-based product”, refers to a meat preparation, comprising finely- or/and coarsely-comminuted meat mass or meat particles or/and mixtures thereof, which has been subjected to a thermal treatment, following encasing into suitable easy-to-peel tubular packages. Furthermore, the general terms “meat-based products” refer to thermally processed finely-comminuted meat based products (e.g. cooked sausages, bologna, mortadella and the like), thermally processed coarsely-comminuted meat based products, thermally processed reconstituted meat products comprising meat particles that retain the integrity of the muscle tissue (e.g. reconstituted chicken fillets, reconstituted turkey fillets, reconstituted ham and the like) or/and thermally processed whole muscular-based meat products (e.g. cooked ham, cooked turkey breast), which comprise meat particles derived from whole muscular meat pieces, subjected to brine injection., tumbling and subsequently reduction in size. Preferably, the present invention does not relate to spreadable and/or fermented meat products. Moreover, the term “thermally processed” refers to the meat-based products which were subjected to a process equivalent to pasteurization, according to the known practices. Preferably, the term “thermally processed” refers to meat-based products heated to obtain a core temperature up to 72° C. for 15 sec.

According to preferred embodiments, the snack-sized cooked meat products have a weight ranging from 15 gr to 85 gr, preferably a weight range from 20 to 75 gr, more preferably a weight range from 25 to 55 gr and even more preferably a weight range from 30 to 45 gr. Moreover, the snack-sized cooked meat product can have a length from 5 cm to 20 cm, preferably a length from 5 cm to 15 cm and more preferably a length from 8 cm to 12 cm. In addition, the snack-sized cooked meat product can have a diameter ranging from 15 mm to 40 mm, preferably a diameters ranging from 15 mm to 30 mm.

The snack-sized product of the present invention is preferably provided in an easy-to-peel tubular package comprising an easy-to-peel packaging film. Preferably, said packaging film is made from heat-sealable material or materials and comprises more than one layer. In a preferred embodiment, the packaging film comprises at least two layers, the one layer comprising at least Polyethylene and the other comprising at least Polyamide. Preferably, the easy-to-peel tubular package is further characterized by a heat-sealed field, which is preferably located on the longitudinal axis of said package. According to a preferred embodiment of the present invention, the package further comprises a free non-sealed surface, which extends adjacent and parallel to the heat-sealed field. The non-sealed surface has a number of tear notches, perpendicular to the heat-sealed field, that allow the opening of the package by a rotational motion.

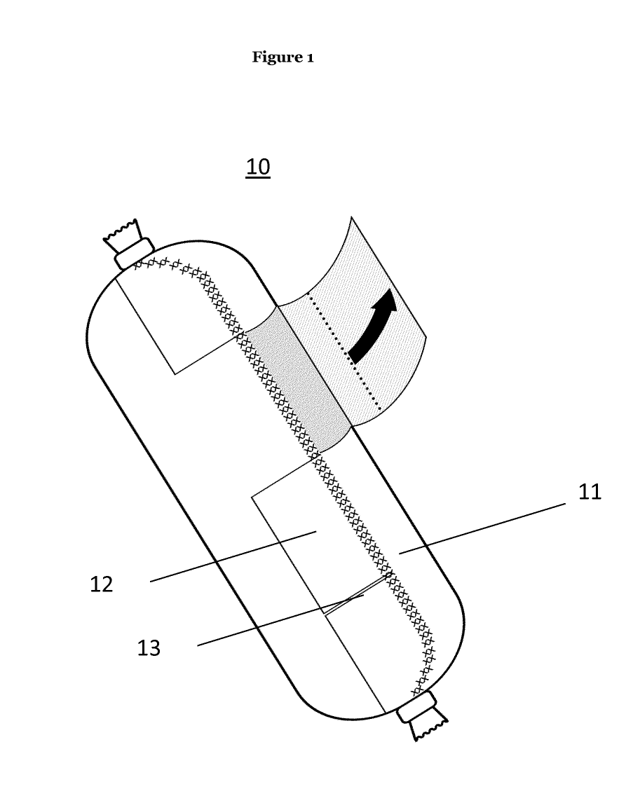

FIG. 1 shows an easy-to-peel package according to one embodiment of the invention.

The seal strength of the easy-to-peel package should be such to permit manual opening of the package, even by children. A peelable layer and layer interface according to the present invention preferably have initial seal/peel strength >5 N/15 mm (as by DIN EN ISO 527). The total packaging film thickness is preferably between 30-100 μm, more preferably between 50-100 μm. The packaging film suited for the herein disclosed applications, have the appropriate tear resistance, elongation at break and tensile modulus properties, suitable for meat product (chub-type) packaging applications. In a preferred embodiment, the elongation at break MD is at least 80% and the elongation at break CD is at least 90% (as by DIN EN ISO 527). Moreover, in preferred embodiments the packaging film used in the present invention, provides a limited permeability to oxygen, preferably <35 cm³/m²/d (DIN 53380), a water vapour permeability preferably <3 g/m²/d (DIN 53122) and a carbon dioxide permeability preferably <123 cm³/m²/d (DIN 53380).

The easy-to-peel packaging film forms the heat-sealed tubular casing and the latter is filled with the raw meat preparation, said filled tubular casing is finally closed with a top seal and a bottom seal, by the combination of a form-fill-seal machine and a feeder system. Preferably, said form-fill-seal machine is a Horizontal Form-Fill-Seal machine (HFFS). A Form-Fill-Seal (FFS) machine initially processes flat films from a roll into a tubular member. A forming shoulder forms the flat film around a stuffing horn into an open tube. The tube is then sealed lengthwise by heat seal. The heat sealed tubular casing is made available in the close proximity of a filling tube. At the beginning of the filling process, a double clipping device closes the one end of the heat sealed tubular casing. Through the filling tube, the meat mass starts to be discharged and fills the casing. Once filling of a defined item is completed, the double clipping machine seals the right end of the stuffed casing and the left end of the successive item for the process to be continued.

The FFS machine is preferably equipped by sensors to ensure for example the supply of casing material in precise lengths, or the absence of metal contaminants The FFS machine is preferably further equipped by metering devices, shut-off valves and flow-controlling tooling, to ensure weight accuracy in the final product.

One embodiment is a method comprising the following steps:
a) Providing a raw meat preparation;
b) Providing an easy-to-peel tubular package, in particular of a diameter 15-40 mm and a length ranging between 5 cm-20 cm;
c) Filling the easy-to-peel tubular package of step (b) with the raw meat preparation of step (a);
d) Thermally processing the product of step (c).

In step (a) of the above-described method, the raw meat preparation can be prepared by any process known and is not restricted. Preferably, the meat is selected from meat derived from beef, pork, chicken, lamb, calve, canard, goose, fish or other species fit for human consumption and/or mixtures thereof. The meat preparation of step (a) may contain “other ingredients”, as defined above. The meat preparation of step (a) may also contain “additional ingredients”. The term “additional ingredients” as used in this context, comprises any ingredient conventionally used for the production of processed meat products, such as antioxidants, preservatives, flavor enhancers, acidifiers, coloring agents, sugars, seasonings, spices and mixtures thereof.

The raw meat preparation invention has appropriate rheological properties in particular a suitable stress value at flow point, as disclosed above.

According to a first aspect, the meat preparation is substantially homogenous in terms of meat-particle size and is intended for the making of finely-comminuted meat based products of the group comprising cooked sausages, hotdog-type sausages, Bologna-type sausage, Lyoner type-sausage etc. According to a second aspect, the meat preparation is substantially not homogenous in terms of meat-particle size and is intended for the making of two-phase products. The category refers to products comprising a quantity of finely comminuted meat and chunks of meat and/or coarsely comminuted fat particles. The group of two-phase products comprises the Mortadella-type sausages, the Bierschinken-type sausages and the like.

In a preferred embodiment, the meat preparation also comprises a vegetable oil or a mixture of vegetable oils, rich in unsaturated fatty acids, such as olive oil, canola oil, soybean oil etc.

Preferably, the raw finely comminuted meat paste intended for the making of finely-comminuted meat based products has a ratio of protein:moisture of about from 1:5.0 to about 1:6.5 and preferably from 1:5.5 to 1:6.5. The same is further characterized by an average fat content of about from 3% (wt) to 20% (wt) and an average polysaccharide content preferably in the range from 0.1% (wt) to 8.0% (wt). A finely-comminuted meat mass may be produced as known in the art for the making of meat-products based on finely comminuted meat mass. An exemplary method for the preparation of a finely comminuted meat preparation is the following: Meat with the desirable fat content is finely comminuted in the presence of table salt and nitrite salt inside the bowl of a cutter with successive addition and mixing of water/ice, other ingredients and additional ingredients, up to the full homogenization of the mixture, by gradually increasing the cutting speed until the desired chopping effect is achieved. It is preferred that the temperature during the preparation of the finely comminuted meat paste does not exceed 15° C., more preferably 12° C. and most preferably 8° C.

In an alternative embodiment, the meat preparation is intended for the making of coarsely comminuted meat products or reconstituted products or whole muscular tissue-based products. The group of reconstituted products comprises the reconstituted ham, reconstituted chicken fillet, reconstituted turkey breast etc. In addition, the group of whole muscular meat-based products comprises the cooked ham, cooked chicken fillet, cooked turkey breast etc. Preferably, the meat preparation, suitable for the above mentioned product types, is composed of a comminuted meat preparation, comprising meat particle size up to 30 mm. The raw comminuted meat preparation, primarily comprising meat particles, intended for reconstituted meat-based products and/or whole muscular tissue-based products, has an average protein:moisture ratio of about from 1:3.0 to about 1:6.5 and preferably from 1:4.0 to 1:6.2. The same is further characterized by an average fat content of about 0.5% (wt) to 5.0% (wt) and an average polysaccharide content preferably in the range from 0.1% (wt) to 5.0% (wt).

An exemplary method for the preparation of a reconstituted meat-based product is the following: A coarsely comminuted meat mass is produced preferably by passing integral meat pieces through a grinder, as the initial step, in order to obtain meat particles of about 10 mm±2. Then, the ground meat is transferred to a tumbler/massager, where it is further processed by massaging (e.g. for 3 hours continuously at 8 rpm, at a temperature 4° C. and incline of)60°, in the presence of an appropriate brine (e.g. 60% wt of the meat to be added). It is preferred that the temperature during the tumbling/massaging of the coarsely comminuted meat paste does not exceed the 6° C., more preferably does not exceed the 4° C.

Moreover, an exemplary method for the preparation of whole muscular meat-based products is the following: Meat pieces are brine injected (e.g. with a brine quantity of about 60% wt of the meat to be added) and then tumbled according to known practices (e.g. for 5 hours continuously at 8 rpm, at a temperature 4° C. and incline of 60°). It is preferred that the temperature during the tumbling of the whole muscular meat pieces does not exceed the 6° C., more preferably does not exceed the 4° C. The brine-injected and tumbled meat pieces are then comminuted to the desired size, e.g. by the use of grinder.

According to a second aspect, the meat preparation is substantially not homogenous in terms of meat-particle size and is intended for the making of two-phase products. The category refers to products comprising a quantity of finely comminuted meat and chunks of meat and/or coarsely comminuted fat particles. The group of two-phase products comprises the Mortadella-type sausages, the Bierschinken-type sausages and the like.

Preferably, the raw meat preparation intended for the making of two-phase products, has a meat/fat particle size equal to about 6 mm±2. In this aspect, the raw meat preparation has an average protein:moisture ratio of about from 1:4.5 to about 1:6 and preferably from 1:4.5 to 1:5.5. The same is further characterized by an average fat content of about 3% (wt) to 30.0% (wt) and an average polysaccharide content is of about 0.1% (wt) to 10.0% (wt).

An indicative method for the making of a meat preparation suited for the production of two-phase products includes the admixture in a processing machine (e.g. mixer, or bowl chopper) of two preparations, namely of a coarsely comminuted meat preparation/fat tissue and a finely comminuted meat preparation, in a ratio between 1:1 to 1:4.

The finely comminuted meat, herein defined as the first phase preparation, is made as described in a previous section and is subsequently combined with the preparation of the second phase comprising meat chunks or coarsely comminuted fat tissue. Processing follows in an appropriate apparatus (e.g. bowl chopper) to obtain the desired degree of comminution of the second phase.

For step (b), an easy-to-peel tubular package, in particular of a diameter 15-40 mm and a length between 5-20 cm, is produced by an HFFS machine, as described above. In specific, the packaging film takes the form of a tubular member by heat-sealing the side edges of the packaging film at a temperature range between 100-250° C., preferably at a temperature range between 150-200° C., in such a way that a longitudinal heat-sealed seam is produced. The properties of an easy-to-peel packaging film suited for the purpose of the present patent are discussed above.

In step (c) the resulting raw meat preparation is conveyed from the feeder system of the machinery, to the discharge end of the filling tube, as described above, and fills the heat sealed tubular casings. An exemplary method for encasing a meat preparation into 30 gr portions encased into packages of 23 mm diameter wide and 9 cm in length, is the following: The feeder system (e.g. a Handtmann® model VF300) uses vacuum (e.g. >96 bar) to drive the meat preparation to a F-F-S machine (e.g. supplied from Polyclip® System). An indicative flow rate of the meat preparation, from the feeder system is about 11,84 L/min. A tube system conveys then the meat preparation to the FFS machinery, that according to one example, comprises a tube (a) connecting the outlet of the feeder system to a tube (b), at the outlet of which, the meat preparation is discharged. Tube (a) could be for example about 1 m in length and 65 mm of external diameter. Tube (b) for example may be of an external diameter equal to about 14mm (internal diameter equal to about 11 mm) and of a length equal to about 125 cm.

During the filling at the end of tube (b), the casing is withdrawn from a casing reservoir. An indicative speed with which the casing is withdrawn from the reservoir during the filling operation is about 15.5-18.0 m/min. A number of about 175 filled and clipped items may be produced per min, having the dimensions, as abovementioned.

The portions (chubs) should be characterized by uniform shape, precision and weight accuracy.

Thermal processing of the encased meat preparation, in step (d) involves pasteurization, according to the common knowledge. Preferably, the snack-sized portions of encased meat preparations are laid into perforated trays to ensure homogeneity of thermal treatment. Thermal treatment is a liquid thermal treatment, preferably conducted by steam cookers or water-baths, for example until a product core temperature of about 72° C. is reached for about 15 sec. Following the thermal treatment, the thermally processed snack-sized meat-based products are preferably not spreadable. Thus, according to a preferred embodiment, the thermally processed snack-sized meat products of the present invention have a solid state. The portions subjected to thermal treatment retain their cylindrical shape and the protein matrix keeps substantially all meat juices without creating jelly spots between the meat mass and the casing.

Another embodiment of the present invention is a product deriving from a method comprising the following steps:
a) Providing a raw meat preparation;
b) Providing an easy-to-peel tubular package, in particular of a diameter 15-40 mm and a length ranging between 5 cm-20 cm;
c) Filling the easy-to-peel tubular package of step (b) with the meat preparation of step (a);
d) Thermally processing the product of step (c).

Steps (a) to (d) are described in detail in the paragraphs above.

FIG. 1 is a schematic representation of a preferred easy-to-peel package (10) suited for encasing a snack-sized thermally processed meat-based product.

According to FIG. 1 the package design, which facilitates the easy-to-peel function is characterized by: i) a heat-sealed field on the longitudinal axis of the container (11), ii) a free non-sealed surface, parallel to the heat-sealed field (12), having a number of tear notches (13) perpendicular to the heat-sealed field, of a length equal to 10 mm +/− 3 mm and at a space between two successive tear notches of about 20 mm +/− 1 mm. The presence of tear notches allows the removal of the package by rotational motion.

The present invention will now be further illustrated by the following example without limiting its scope.

### EXAMPLE

### A Snack-Sized Thermally Processed Reconstituted Ham Product Provided in a Easy-To-Peel Tubular Package

A reconstituted ham product was made using the ingredients of Tables 1 and 2.

The brine ingredients shown in Table 2 were mixed to form the brine solution listed in Table 1. The brine solution was then added into the tumbler/massager vessel (Günther tumbler model GPA 200 k), together with the ground meat mass (meat particle size up to 10 mm), before commencing a typical massaging process (about 3 hours at 8 rpm and incline of 60°). Following the massaging process, an amplitude sweep test was performed at a temperature of 15° C. and at a frequency of 1 Hz, whereby the flow point of the raw meat preparation was measured to be 950 Pa. The ready raw meat preparation was then transferred to a feeder system (e.g. a Handtmann® model VF300) connected with a horizontal F-F-S machine (e.g. supplied from Polyclip® System). The procedure followed is as described above for the production of 30 gr snack-size products. Then, pasteurization followed, contacted by a steam cooker until a product core temperature of about 72° C. is reached for about 15 sec.

TABLE 1
Basic Formulation

| Ingredients | % of the final product |
|---|---|
| Pork Leg visually lean | 62.50 |
| Brine | 37.50 |

TABLE 2
Brine Composition

| Ingredients | % of the final product |
|---|---|
| Water | 30.240 |
| Sodium Di& TriPhosphates | 0.450 |
| Nitrite Salts (15% NaNO2) | 0.094 |
| Sodium Erythorbate | 0.060 |
| Dextrose | 1.030 |
| Salt | 1.870 |
| Native Starch | 2.810 |
| Carrageenan | 0.560 |
| Seasonings | 0.386 |

1. A method of producing a snack-sized thermally processed meat-based product, provided in an easy-to-peel tubular package, comprising the steps of:
a) Providing a raw meat preparation;
b) Providing an easy-to-peel tubular packaging film;
c) Filling the easy-to-peel tubular packaging film with the raw meat preparation of step (a) and closing with a top seal and a bottom seal;
d) Thermally processing the product of step (c),
wherein the raw meat preparation of step (a) characterized by an amplitude sweep test (strain), at a temperature of 15° C. and at a frequency of 1 Hz, has a stress value at flow point lower than 2000 Pa.

2. The method of claim 1, wherein the stress value at flow point, determined by an amplitude sweep test (strain), at a temperature of 15° C. and at a frequency of 1 Hz, is lower than 1800 Pa and more preferably lower than 1650 Pa.

3. The method of claim 1, wherein the raw meat preparation of step (a) further characterized by an amplitude sweep test (strain), at a temperature of 15° C. and at a frequency of 1 Hz has a complex viscosity at the flow point, lower than 450 Pa*s, preferably lower than 400 Pa*s and more preferably lower than 350 Pa*s.

4. The method of claim 1, wherein the raw meat preparation of step (a) is characterized by a protein-to-water ratio of 1:3 to 1:7.

5. The method of claims 1, wherein the raw meat preparation comprises a vegetable oil or a mixture of vegetable oils.

6. The method of claim 1, wherein the easy-to-peel tubular package is a cook-in-ship-package.

7. The method of claim 1, wherein the easy-to-peel tubular packaging film of step (b) is made from heat-sealable material or materials and comprises more than one layer.

8. The method of claim 1, wherein the easy-to-peel tubular packaging film of step (b) comprises at least two layers, the one layer comprising at least polyethylene and the other comprising at least polyimide.

9. The method of claim 1, wherein the easy-to-peel tubular package is further characterized by a heat-sealed field, which is located on the longitudinal axis of said package.

10. The method of claim 1, wherein the easy-to-peel tubular package is formed by an easy-to-peel packaging film by the use of a Form-Fill-Seal machine.

11. The method of claim 1, wherein step d) is a process comprising pasteurization.

12. A snack-sized thermally processed meat-based product, provided in an easy-to-peel tubular package, obtainable by a method of claim 1.
